(19) United States
(12) Patent Application Publication
(10) Pub. No.: US 2023/0358852 A1
(43) Pub. Date: Nov. 9, 2023

(54) SIGNAL MULTIPLEXING FOR DATA AND RADAR TRANSMISSIONS

(71) Applicant: Nokia Technologies Oy, Espoo (FI)

(72) Inventors: Volker BRAUN, Stuttgart (DE); Harish VISWANATHAN, Basking Ridge, NJ (US); Thorsten WILD, Stuttgart (DE)

(21) Appl. No.: 18/042,371

(22) PCT Filed: Aug. 25, 2020
(86) PCT No.: PCT/EP2020/073725

§ 371 Date: Feb. 21, 2023

(51) Int. Cl. G01S 7/00; G01S 7/02

(52) U.S. Cl. CPC G01S 7/003; G01S 7/0232; G01S 7/0235

(57) ABSTRACT

Systems, methods, apparatuses, and computer program products for signal multiplexing of data and radar transmissions. For instance, certain embodiments may provide a configurable time and frequency domain comb signal for radar excitation on a spatial beam and/or multiplexing data communications and radar signals in time, frequency, and/or spatial domains (e.g., beams).

### FIELD

Some example embodiments may generally relate to mobile or wireless telecommunication systems, such as Long Term Evolution (LTE) or fifth generation (5G) radio access technology or new radio (NR) access technology, or other communications systems. For example, certain embodiments may relate to systems and/or methods for signal multiplexing for data and radar transmissions.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. 5G is mostly built on a new radio (NR), but a 5G (or NG) network can also build on E-UTRA radio. It is estimated that NR may provide bitrates on the order of 10-20 Gbit/s or higher, and may support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G, the nodes that can provide radio access functionality to a user equipment (i.e., similar to Node B in UTRAN or eNB in LTE) may be named gNB when built on NR radio and may be named NG-eNB when built on E-UTRA radio.

### SUMMARY

According to a first embodiment, a method may include scheduling one or more radar transmissions and one or more data transmissions by: utilizing a grid of time-frequency resources for the one or more radar transmissions, and multiplexing the one or more radar transmissions and the one or more data transmissions with each other with respect to the grid of time-frequency resources. The method may include transmitting signaling that indicates the scheduling of the one or more radar transmissions or the one or more data transmissions. The method may include transmitting the one or more radar transmissions and the one or more data transmissions.

In a variant, a density of time resources of the time-frequency resources that carry the one or more radar transmissions may provide a velocity range for a radar target. In a variant, a time duration of the one or more radar transmissions may provide a velocity resolution for the one or more radar transmissions. In a variant, a density of frequency resources of the time-frequency resources may provide a distance range for a radar target. In a variant, a bandwidth of the one or more radar transmissions may provide a distance resolution for the one or more radar transmissions.

In a variant, different time resources may be scheduled for different radar transmissions from different cells or beams of a cell. The different cells or beams of the cell may be different spatial resources. In a variant, different frequency resources may be used for radar transmissions from different cells or beams of a cell. The different cells or beams of the cell may be different spatial resources. In a variant, a radar transmission on a spatial beam may be used for a data transmission of the one or more data transmissions. In a variant, the one or more data transmissions and the one or more radar transmissions may be jointly used for radar processing. In a variant, one or more other time-frequency resources not included in the grid of the time-frequency resources for the one or more radar transmissions may be scheduled for at least one radar transmission of the one or more radar transmissions.

In a variant, a subset of the time-frequency resources for the one or more radar transmissions may be excluded for the one or more data transmissions. In a variant, the subset may be static from a perspective of a receiving device. In a variant, scheduling the one or more radar transmissions and the one or more data transmissions may further include scheduling the one or more radar transmissions and the one or more data transmissions by grouping the one or more radar transmissions across spatial resources. In a variant, grouping the one or more radar transmissions across the spatial resources may include allocating two or more of the spatial resources on adjacent resources in a time domain or a frequency domain.

A second embodiment may be directed to receiving signaling that indicates a scheduling of one or more radar transmissions or one or more data transmissions according to: a grid of time-frequency resources for the one or more radar transmissions, and a multiplexing of the one or more radar transmissions and the one or more data transmissions with each other with respect to the grid of time-frequency resources. The method may include receiving, based on the scheduling, the one or more data transmissions on one or more time or frequency resources that are not scheduled for the one or more radar transmissions.

In a variant, a subset of frequency resources or time resources of the time-frequency resources for the one or more radar transmissions may be excluded for the one or more data transmissions. In a variant, the subset may be static from a perspective of the receiving device. In a variant, the method may include receiving an indication of the excluded time resources. In a variant, the method may include determining to ignore the excluded time resources based on the scheduling. In a variant, the method may include receiving the one or more radar transmissions. In a variant, the one or more radar transmissions may carry the one or more data transmissions. In a variant, the scheduling may be further according to a grouping of the one or more radar transmissions across spatial resources.

A third embodiment may be directed to an apparatus including at least one processor and at least one memory comprising computer program code. The at least one memory and computer program code may be configured, with the at least one processor, to cause the apparatus at least to perform the method according to the first embodiment or the second embodiment, or any of the variants discussed above.

A fourth embodiment may be directed to an apparatus that may include circuitry configured to perform the method according to the first embodiment or the second embodiment, or any of the variants discussed above.

A fifth embodiment may be directed to an apparatus that may include means for performing the method according to the first embodiment or the second embodiment, or any of the variants discussed above. Examples of the means may include one or more processors, memory, and/or computer program codes for causing the performance of the operation.

A sixth embodiment may be directed to a computer readable medium comprising program instructions stored thereon for performing at least the method according to the first embodiment or the second embodiment, or any of the variants discussed above.

A seventh embodiment may be directed to a computer program product encoding instructions for performing at least the method according to the first embodiment or the second embodiment, or any of the variants discussed above.

### BRIEF DESCRIPTION OF THE DRAWINGS

For proper understanding of example embodiments, reference should be made to the accompanying drawings, wherein:

FIG. 1 illustrates an example of signal multiplexing for data and radar transmissions, according to some embodiments;

FIG. 2 illustrates an example of a time-frequency comb signal for radar excitation, according to some embodiments;

FIG. 3 illustrates an example allocation of frequency domain comb signals within a physical resource block (PRB), according to some embodiments;

FIG. 4 illustrates an example of an allocation of multiple frequency domain comb signals within a PRB, according to some embodiments;

FIG. 5 illustrates an example of simultaneous transmission of data and radar excitation signals on different beams, according to some embodiments;

FIG. 6 illustrates an example of resource allocation configurations of time domain symbols used jointly for synchronization signal block (SSB) and radar excitation, according to some embodiments;

FIG. 7 illustrates an example of a time-frequency comb for signal grouping across cells, according to some embodiments;

FIG. 8 illustrates an example flow diagram of a method, according to some embodiments;

FIG. 9 illustrates an example flow diagram of a method, according to some embodiments;

FIG. 10a illustrates an example block diagram of an apparatus, according to an embodiment; and

FIG. 10b illustrates an example block diagram of an apparatus, according to another embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for signal multiplexing for data and radar transmissions is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments. In addition, the phrase “set of” refers to a set that includes one or more of the referenced set members. As such, the phrases “set of,” “one or more of,” and “at least one of,” or equivalent phrases, may be used interchangeably. Further, “or” is intended to mean “and/or,” unless explicitly stated otherwise.

Additionally, if desired, the different functions or operations discussed below may be performed in a different order and/or concurrently with each other. Furthermore, if desired, one or more of the described functions or operations may be optional or may be combined. As such, the following description should be considered as merely illustrative of the principles and teachings of certain example embodiments, and not in limitation thereof.

Radar (radio detection and ranging) may be an emerging use case for wireless communications systems. As an example, NR or beyond 5G systems may be used both for exchanging data with mobile users and for, e.g., pedestrian or vehicular traffic monitoring when deployed along roads. The transmit signal of the radar system may be reflected by the target (e.g., a human or a car), and by processing the received signal it may be possible to derive target properties, such as distance, horizontal/vertical direction, velocity, and/or size in the near field of the radio base station.

Orthogonal frequency division multiplex (OFDM) radar may be a system design approach to enable joint communication and short range sensing. With OFDM radar, a downlink (DL) signal carrying actual data (e.g., the OFDM resource elements carrying quadrature amplitude modulation (QAM) symbols) can be used as the excitation signal, and there may be no need to consume DL capacity for sensing.

Short range radar systems may use simultaneous transmission of the radar excitation signals and reception of the reflected radar excitation signals. This can be implemented by means of a full-duplex transceiver, by means of antenna separation, or by a combination of both. Full-duplex receivers for OFDM radar may be complex to implement.

The radio base station may apply antenna arrays to increase the covered area by communicating with the UEs via narrow directive beams, particularly when using higher carrier frequencies in the centimeter (cm) or millimeter (mm) wavelength ranges. With a beam-based air interface, the radar excitation signals may have to be transmitted on all beams to obtain a full image of the covered area, which may be referred to as a beam sweep. In such a case, the data transfer may be limited to the subset of users that can be reached with the (narrow) active beam. This may lead to undesirable scheduling constraints.

The typical signal processing for OFDM radar may include a two-dimensional Fourier transform to compute a periodogram with N columns and M rows, where N may denote the number of active subcarriers and M may denote the number of OFDM symbols carrying the excitation signals. In the obtained periodogram, the maximum position column-wise may relate to the distance of the target (e.g., delay of the echo signal), and row-wise to the target velocity (e.g., Doppler shift of the echo signal). The periodogram may be computed from normalized frequency domain symbols, e.g., QAM symbols, where each received symbol may be divided by the transmitted symbol prior to Fourier transform processing. The periodogram may benefit from an improvement of the signal-to-noise ratio (SNR) by a factor N times M versus the SNR at the receive antenna, which may be referred to as the processing gain.

Since the processing gain may become large, it may be permissible to use a subset of the available subcarriers and time domain symbols for radar excitation. This may reduce the maximum unambiguous range and velocity, respectively, of the radar.

From the above, there may be a need to design a radar excitation signal suitable for embedding into a multi-carrier (e.g., OFDM-based) communications air interface. In addition, there may be a need to organize the radar excitation signals in a multi-beam multi-cell environment, to multiplex the signals carrying data and radar excitation signals, and/or to deal with a variety of use cases and hardware architectures (e.g., analog/digital/hybrid beamforming).

Some embodiments described herein may provide for signal multiplexing of data and radar transmissions. For instance, certain embodiments may provide a configurable time and frequency domain comb signal for radar excitation on a spatial beam and/or may provide for multiplexing data communications and radar signals in time, frequency, and/or spatial domains (e.g., beams). This may allow flexibility in scheduling data and radar transmissions. In addition, certain embodiments may provide for interference mitigation, such as inter-cell interference mitigation (e.g., through the grouping of data transmissions and radar transmissions across spatial resources or by frequency-orthogonal allocation of radar excitation signals).

Certain embodiments may utilize radar signal time and frequency allocation. A density of time domain symbols carrying the radar excitation signal may be dimensioned to provide a certain velocity (e.g., a velocity limit, such as a maximum unambiguous velocity). A time duration (e.g., the number of time domain symbols) of the radar excitation signal may be dimensioned to provide a certain velocity resolution. A density of subcarriers for radar excitation may be dimensioned to provide a certain range (e.g., a limit on the range, such as a maximum unambiguous range). A bandwidth (the number of subcarriers) of the radar excitation signal may be dimensioned to provide a certain distance resolution (or range resolution). A beam sweep may partly be carried out in the time-domain (e.g., different, such as consecutive, time domain symbols may be used to transmit radar excitation signals from different beams of a cell). The same frequency domain resources may be used in different time-domain symbols for different beams of a cell, e.g., a static subset of frequency domain resources may be excluded from the data transmission in the cell. This may simplify the signalling of resource elements that are to be excluded from the UE channel decoding, as described elsewhere herein.

Certain embodiments may utilize multiplexing of data and radar signals. Resource elements not used for radar excitation may be used for scheduling user data to a UE on a spatial beam or with a spatial precoding (e.g., if supported by hardware capabilities). A radar excitation signal transmitted on a spatial beam may be used for carrying data to a UE capable of receiving data on the same spatial beam. This arrangement of transmissions may be indicated to the UE. For example, a bit field in downlink control information (DCI) may indicate which of the radar signal components overlapping with the granted resources may be used by the UE for channel decoding. Alternatively, this may be indicated to the UE by providing radar beam sweep information, for example, the UE may receive information indicating which time-domain symbols may be used for radar beam sweep. The carried information in the time-frequency radar excitation signal may be broadcast or multicast information delivered to one or more UEs. A device performing the radar processing may need to know the transmitted data symbols, which may be possible to determine due to the co-located nature of the communication system's transmitter device and radar processing receiver device.

Beam sweeping performed in the system for synchronization signals or for beam selection may be used for radar. In this case, primary synchronization signal (PSS)/secondary synchronization signal (SSS) or physical broadcast channel (PBCH) may use all or a subset of the resource elements of the time-frequency grid, which can serve as radar excitation signals. Alternatively, also beam sweeping for other reference signals may be used for radar, for example, by using cell-specific channel state information reference signals (CSI-RS) or a positioning reference signal (PRS) configuration option of the NR system.

Certain embodiments may utilize signaling of resource allocation. The UE may be informed about a subset of resource elements that may be excluded from the data transmissions. These resource elements may be ignored by the UE channel decoder. If the transmission of the radar excitation signal on a beam is periodic, this information may be static, e.g., provided via radio resource control (RRC) signaling. Scheduling grants may be used to avoid overlap of data allocations with radar excitation signals, such as in the time-domain.

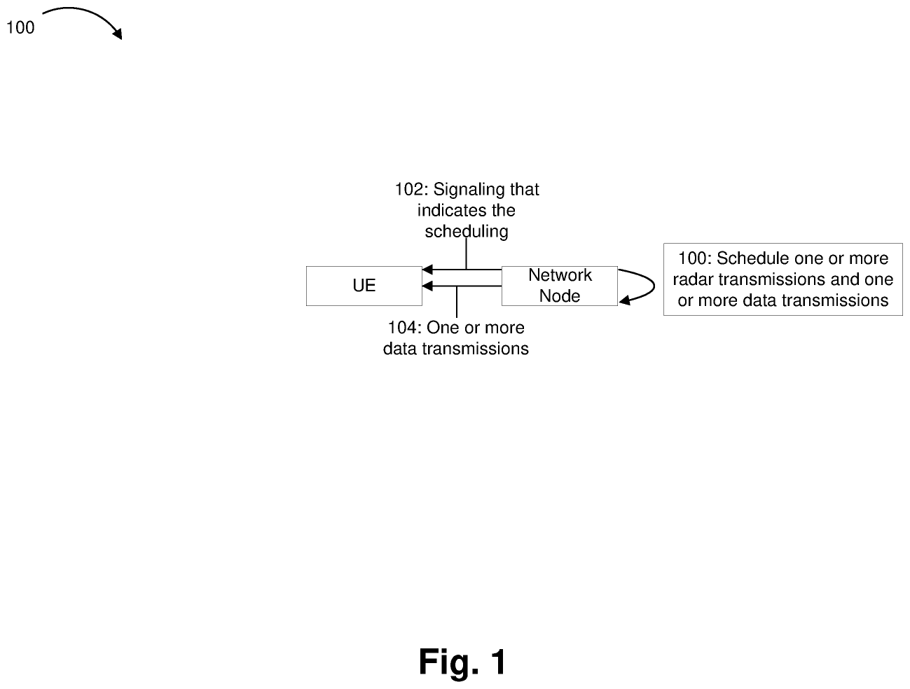

FIG. 1 illustrates an example 100 of signal multiplexing for data and radar transmissions, according to some embodiments. The example 100 of FIG. 1 illustrates a UE and a network node. As illustrated at 100, the network node may schedule one or more radar transmissions and one or more data transmissions. The network node may schedule the one or more radar transmissions and the one or more data transmissions by utilizing a grid of time-frequency resources (e.g., a comb of time-frequency resources) for the one or more radar transmissions. Additionally, or alternatively, the network node may schedule the one or more radar transmissions and the one or more data transmission by multiplexing the one or more radar transmissions and the one or more data transmissions with each other with respect to the grid of time-frequency resources. Additionally, or alternatively, the network node may schedule the one or more radar transmissions and the one or more data transmission by grouping the one or more radar transmissions and the one or more data transmissions across spatial resources (e.g., across different beams, cells, and/or the like). Grouping the one or more radar transmissions and the one or more data transmissions may include allocating two or more spatial resources (e.g., cells or beams of a cell) on adjacent resources in the time and/or frequency domains. For example, two (neighboring) cells may use adjacent subcarriers or two beams of a cell may use adjacent time domain symbols. In this way, certain embodiments may obtain a set of resource elements (e.g., a contiguous set) that simplifies signaling to the UE, e.g., to ignore those resources.

As illustrated at 102, the network node may transmit, and the UE may receive, signaling that indicates the scheduling. For example, the signaling may indicate time resources (e.g., symbols), frequency resources (e.g., subcarriers), and/or spatial resources on which the one or more data transmissions are to be transmitted by the network node, that are to be excluded from being used for the one or more radar transmissions or the one or more data transmissions, and/or the like. As illustrated at 104, the network node may transmit, and the UE may receive, the one or more data transmissions. The UE may process the one or more data transmissions. The network node may additionally transmit the one or more radar transmissions to a radar target.

As described above, FIG. 1 is provided as an example. Other examples are possible, according to some embodiments.

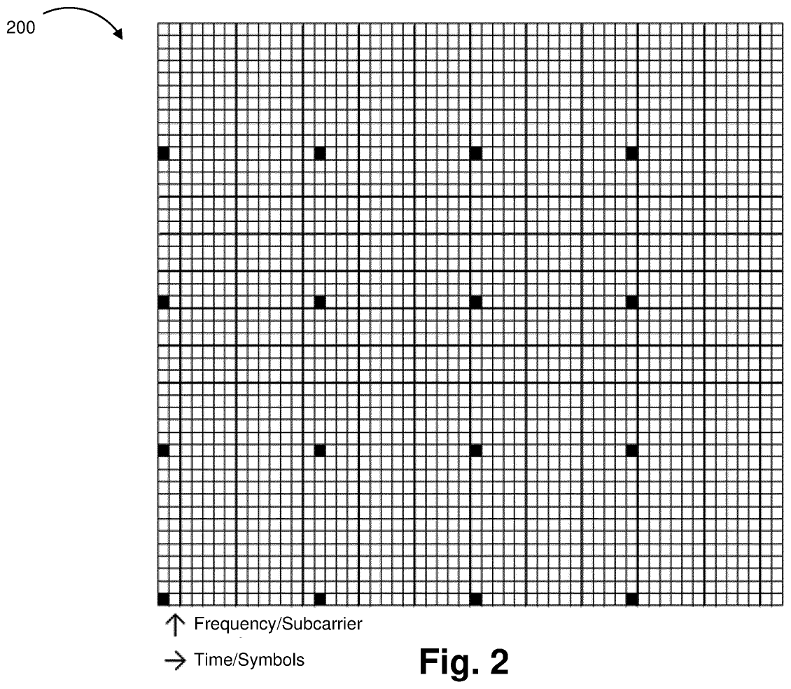

FIG. 2 illustrates an example 200 of a time-frequency comb signal for radar excitation, according to some embodiments. In particular, FIG. 2 illustrates an exemplary allocation of a time-frequency grid signal, for example, with a spacing of n=12 subcarriers and m=14 time-domain symbols of symbol duration TO. Assuming for the example 200 a 28 gigahertz (GHz) carrier frequency and numerology with subcarrier spacing (SCS) equal to 120 kilohertz (kHz) (14 symbols in a 0.125 millisecond (ms) slot), the signal may enable radar measurement on a spatial beam. In the context of example 200, the measurement may utilize a velocity. For example, certain embodiments may utilize a maximum unambiguous velocity of about 154 kilometers per hour (km/h) (+/−77 km/h), given by c/(2 fc m T0), where m may be the spacing between consecutive excitation signals in the time domain, such as 14 in the example of FIG. 2. Additionally, or alternatively, in the context of example 200, the measurement may utilize a range. For example, certain embodiments may utilize a maximum unambiguous range of about 104 meters (m), given by c/(2 n SCS), where n may be the number of sub-carrier spacing between consecutive excitation signals in the frequency domain, such as 12 in the example of FIG. 2. In the previous examples, c may denote the velocity of light and fc may be the carrier frequency.

Achieving a velocity resolution of 10 km/h may need about 1.93 ms time duration. For example, the signal may be allocated in M=16 symbols in time domain (only 4 allocated symbols are shown in FIG. 2). To achieve a distance resolution of 1 m may need a bandwidth of about 150 megahertz (MHz). The signal may be allocated in N=104 subcarriers in frequency domain (only 4 allocated subcarriers are illustrated in FIG. 2). In the example of FIG. 2, the two-dimensional Fourier transform may have 104 rows and 16 columns, which may result in a processing gain of 10 log MN, which may be approximately 32 decibels (dB).

With certain systems, a time-frequency domain comb radar excitation signal may be carried by means of a cell-specific reference signal (CRS). This may enable low complexity radar processing with full-distance resolution (approximately 1/bandwidth (BW)).

As indicated above, FIG. 2 is provided as an example. Other examples are possible, according to some embodiments.

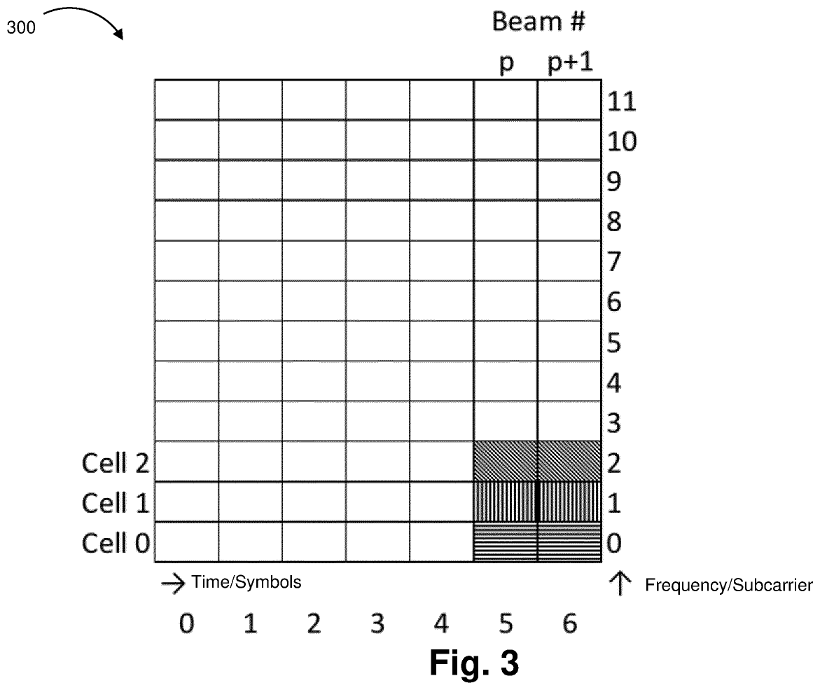

FIG. 3 illustrates an example 300 of allocation of frequency domain comb signals within a physical resource block (PRB), according to some embodiments. In particular, the example 300 may relate to frequency domain multi-cell multi-beam allocation.

FIG. 3 illustrates an example radar signal allocation within a PRB, illustrated as 12 subcarriers and 7 time-domain symbols. Cells 0, 1, 2, which may be co-sited, may be allocated a different subcarrier for radar excitation, e.g., allocated to cell identifier modulo 3 (illustrated as the striped areas in FIG. 3). From each cell, there may be radar excitation signals transmitted on 2 beams, e.g., beams labelled as p and p+1, consecutively. The subcarrier spacing of the frequency domain comb signals may be 12 subcarriers (as in FIG. 2), and the comb may extend over the channel bandwidth. A UE may be scheduled PRBs carrying data on beam p+2 (e.g., if hardware capabilities of the base station allow), on which no radar excitation signal is transmitted with the PRB.

The UE may receive signalling information to exclude subcarriers 0, 1, 2 of the last two time domain symbols of the PRBs from the data reception. The remaining resource elements (indicated by the white areas in the comb illustrated in FIG. 3) may be used for data reception by the UE. Another UE may be scheduled PRBs carrying data on beam p, on which a radar excitation signal is transmitted in time symbol 5 of the PRB. The UE may receive DCI indicating that time symbol 5 may be used for data transmission, together with the resource elements illustrated as the non-striped white areas.

In FIG. 3, the striped areas may be excluded from data transmission. If the radar signals are allocated with frequency hopping across cells 0, 1, 2, e.g., during consecutive radar transmissions, the striped areas may remain static. This may simplify the signalling indication of the resources excluded from data transmission.

As described above, FIG. 3 is provided as an example. Other examples are possible, according to some embodiments.

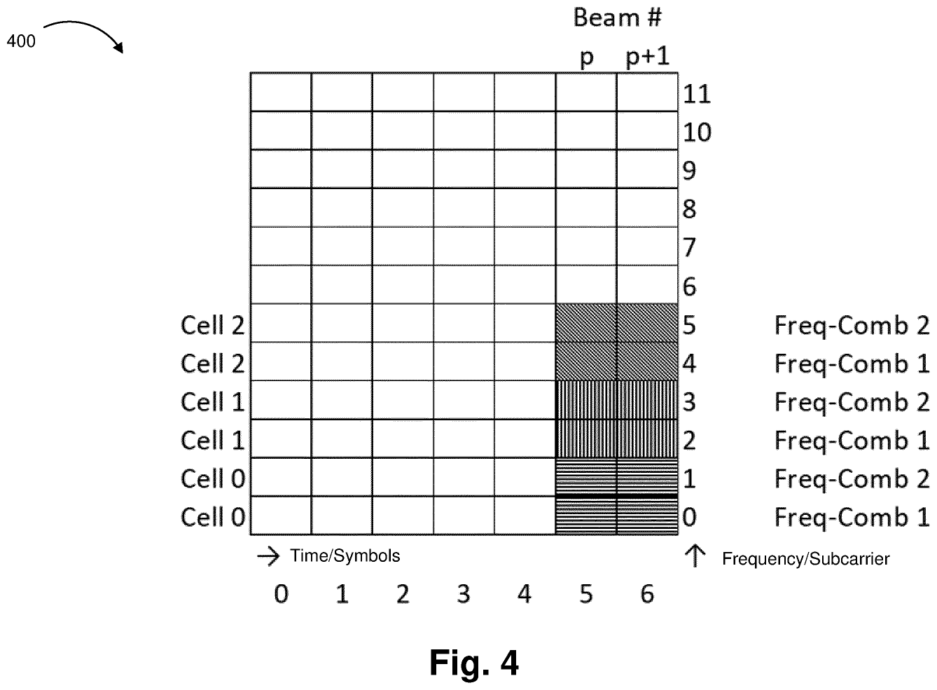

FIG. 4 illustrates an example 400 of allocation of multiple frequency domain comb signals within a PRB, according to some embodiments.

To improve an accuracy of the radar processing, multiple interleaved frequency domain combs may be transmitted simultaneously on a spatial beam. Each of the frequency domain combs may be separately processed by means of a Fourier transform, and the respective range and velocity estimates may be averaged. Alternatively, averaging of normalized receive symbols may take place prior to the Fourier transform processing. This may also be beneficial to simplify the signalling of unused resource elements (REs) for data transmission. An example allocation is depicted in FIG. 4 as the comb. For each cell, two frequency comb signals may be allocated in adjacent subcarriers. In the example of FIG. 4, cell 0 has allocated a first comb in subcarrier 0 and a second comb in subcarrier 1 of the PRB. The frequency domain spacing of each comb signal may be, for example, 48 subcarriers resulting in a 25 m range, which may be suitable for indoor scenarios. In time symbols 5 and 6, the lower half of the PRB may be excluded from data transmission. Similarly, multiple interleaved time-domain combs may be processed and averaged. In certain embodiments, velocity resolution may be improved by extending the time duration for the same signal overhead.

As described above, FIG. 4 is provided as an example. Other examples are possible, according to some embodiments.

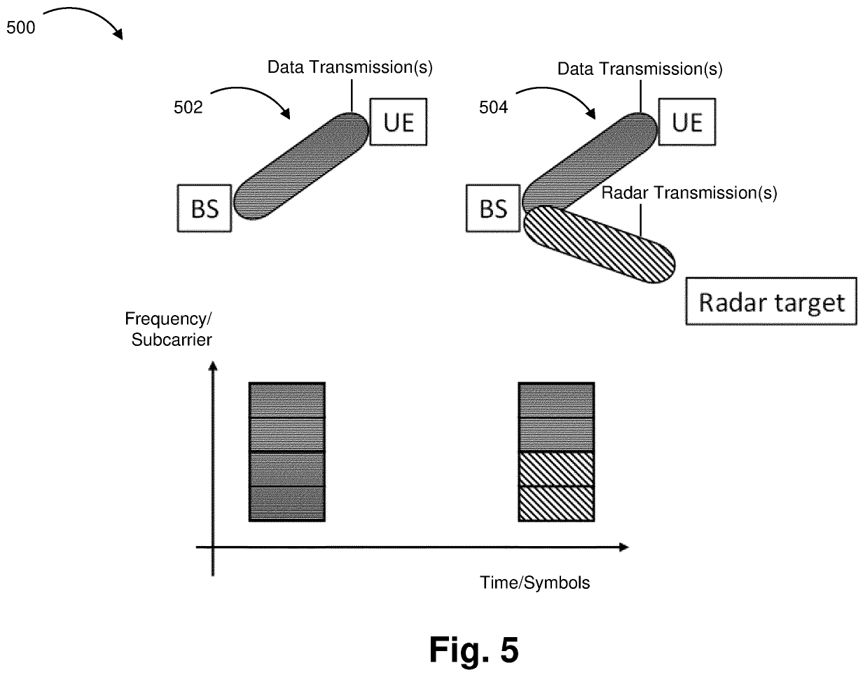

FIG. 5 illustrates an example 500 of simultaneous transmission of data and radar excitation signals on different beams, according to some embodiments. For example, the example 500 may be related to multiplexing of data and radar excitation signals. The example 500 illustrates a base station (BS) and a UE for a scenario 502 and a BS, UE, and a radar target for a scenario 504. The scenario 502 may include use of a symbol that includes data transmissions with no radar transmissions, and the scenario 504 may include use of data transmissions and radar transmissions in a symbol. The symbols in the scenario 502 may be divided into 4 frequencies/subcarriers where the 4 subcarriers in the scenario 502 are used for data transmissions, and the 4 subcarriers in the scenario 504 may be split between data and radar transmissions.

With digital or hybrid beamforming (at least two beams at a time), radar excitation and data signals may be transmitted concurrently on at least two different beams or with at least two different spatial precoders. As illustrated with respect to the scenario 504, for example, REs allocated for radar may be used for radar excitation signal transmission on a first beam. Frequency-orthogonal REs not allocated for radar may be used for data transmission on a second beam.

As described above, FIG. 5 is provided as an example. Other examples are possible, according to some embodiments.

With analog beamforming (one beam at a time), certain time-frequency comb signal structures described herein may be used for radar excitation. For example, the comb may be denser in the frequency domain, for example, with a density of 3 subcarriers.

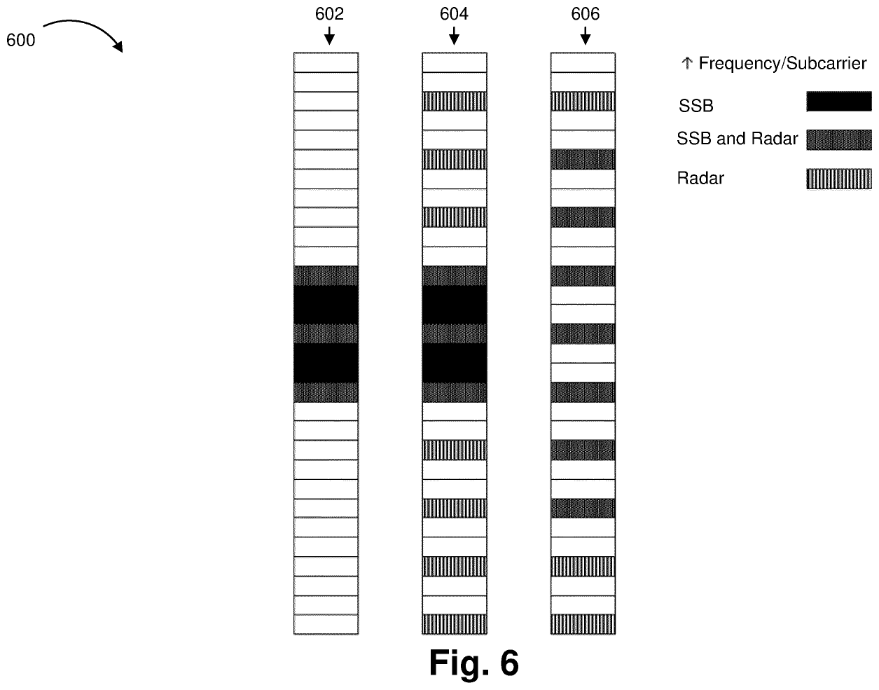

FIG. 6 illustrates an example 600 of resource allocation configurations of time domain symbols used jointly for synchronization signal block (SSB) and radar excitation, according to some embodiments. When SSB time-domain symbols overlap with radar excitation symbols, different frequency-domain allocation configurations may be applied, examples of which are illustrated in FIG. 6 at 602, 604, and 606. Overlap of radar excitation symbols and SSB time-domain symbols may also be avoided, for example, by not scheduling radar excitation signals if they would cause overlap with SSB time-domain symbols.

For example, the radar excitation allocation may be shortened to use the resource elements of SSB, as illustrated at 602. Alternatively, the SSB subcarriers may be complemented with radar symbols over the full channel bandwidth, as illustrated at 604. Alternatively, SSB may use the same frequency domain mapping as the radar excitation signals, as illustrated at 606. The examples illustrated at 602, 604, and 606 may provide different advantages in terms of performance for synchronization and radar, for backwards compatibility with existing technology, as well as for power consumption of the UE. Compared to PSS and SSS of, e.g., LTE or NR, the same (or similar) deterministic sequence design may be applied for PSS and SSS, and the PSS and SSS may be separated further apart in time. For example, PSS and SSS may have a separation of 14 symbols to be aligned with the radar signal grid of FIG. 2. Radar signal transmission of a spatial beam may also use several consecutive symbols (unlike FIG. 3), possibly overlapping with adjacent SSB symbols (e.g., four consecutive SSB symbols may be used).

As described above, FIG. 6 is provided as an example. Other examples are possible, according to some embodiments.

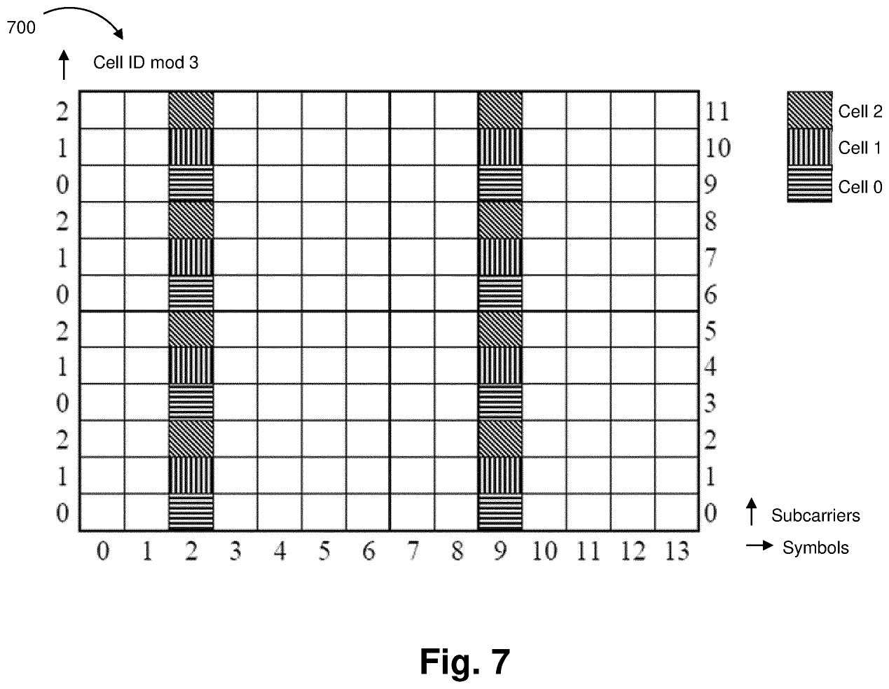

FIG. 7 illustrates an example 700 of a time-frequency comb for signal grouping across cells (e.g., cells 0, 1, and 2, which may be allocated on orthogonal subcarriers), according to some embodiments. In this example, a network node may signal, to a UE, that symbols 2 and 9 are to be ignored for a data transmission from the network node. The example of FIG. 7 may help to mitigate inter-cell interference and may simplify the signalling to UE.

As described above, FIG. 7 is provided as an example. Other examples are possible, according to some embodiments.

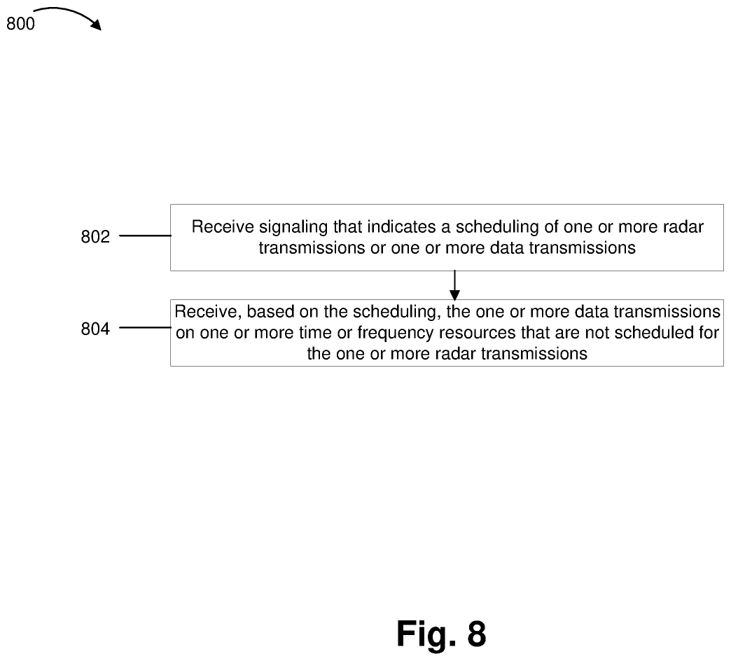

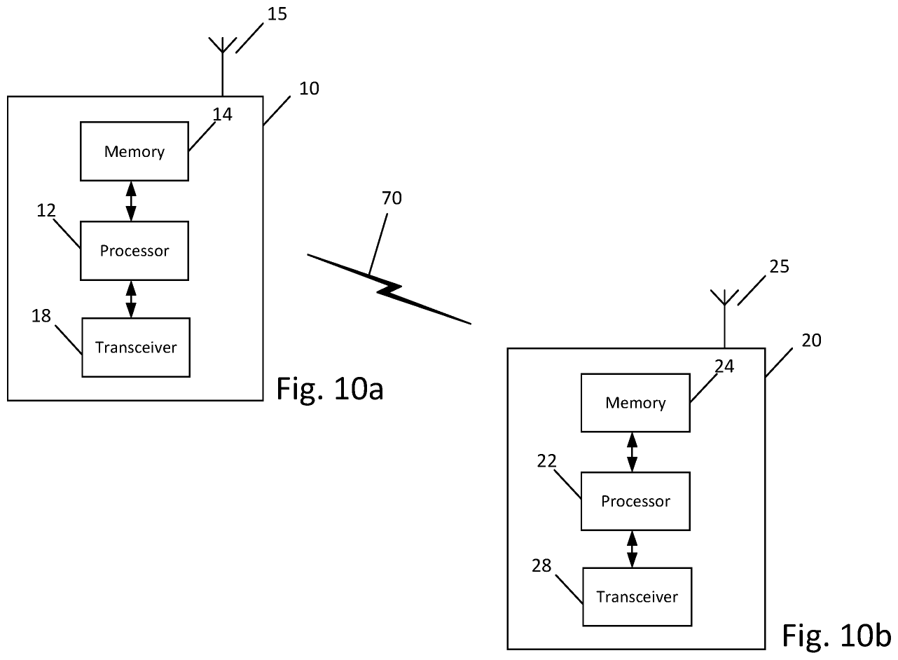

FIG. 8 illustrates an example flow diagram of a method 800, according to some embodiments. For example, FIG. 8 shows example operations of a receiving device (e.g., apparatus 20 illustrated in, and described with respect to, FIG. 10b). In certain embodiments, the receiving device may include a UE, a vehicle, an aerial vehicle, an IoT device, and/or the like. Some of the operations illustrated in FIG. 8 may be similar to some operations shown in, and described with respect to, FIGS. 1-7.

In an embodiment, the method may include, at 802, receiving signaling that indicates a scheduling of one or more radar transmissions or one or more data transmissions. The scheduling may be according to a grid of time-frequency resources for the one or more radar transmissions and/or a multiplexing of the one or more radar transmissions and the one or more data transmissions with each other with respect to the grid of time-frequency resources. The method may include, at 804, receiving, based on the scheduling, the one or more data transmissions on one or more time or frequency resources that are not scheduled for the one or more radar transmissions.

The receiving device may perform one or more other operations described below or elsewhere herein in connection with the method illustrated in FIG. 8. In some embodiments, a subset of frequency resources of time resources of the time-frequency resources for the one or more radar transmissions may be excluded for the one or more data transmissions. In some embodiments, the subset may be static from the perspective of the receiving device (e.g., across cells and/or beams) or static from the perspective of a transmitting device (e.g., over a group of spatial resources, cells, and/or beams). A static subset may include a subset that does not change over time, or that changes fewer than a threshold number of times during a time period. In some embodiments, the method may further include receiving an indication of the excluded time resources. In some embodiments, the method may further include determining to ignore the excluded time resources based on the scheduling. In certain embodiments, the method may include receiving the one or more radar transmissions. In some embodiments, the one or more radar transmissions may carry the one or more data transmissions. In certain embodiments, the scheduling may be according to a grouping of the one or more radar transmissions and the one or more data transmissions across spatial resources.

As described above, FIG. 8 is provided as an example. Other examples are possible according to some embodiments.

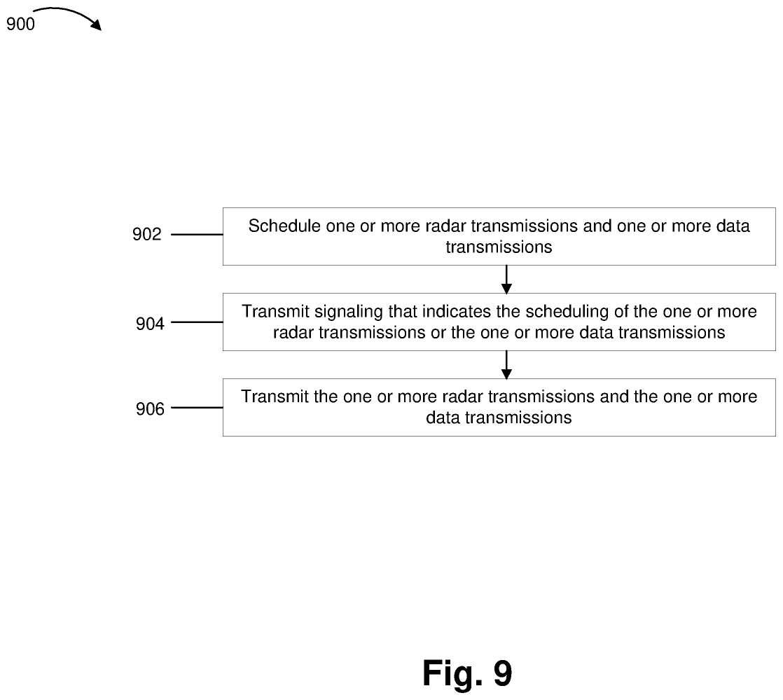

FIG. 9 illustrates an example flow diagram of a method 900, according to some embodiments. For example, FIG. 9 shows example operations of a transmitting device (e.g., apparatus 10 illustrated in, and described with respect to, FIG. 10a). In certain embodiments, the transmitting device may include a base station, a vehicle, an aerial vehicle, an IoT device, and/or the like. Some of the operations illustrated in FIG. 9 may be similar to some operations shown in, and described with respect to, FIGS. 1-7.

In an embodiment, the method may include, at 902, scheduling one or more radar transmissions and one or more data transmissions. The transmitting device may perform the scheduling by utilizing a grid of time-frequency resources for the one or more radar transmissions and/or multiplexing the one or more radar transmissions and the one or more data transmissions with each other with respect to the grid of time-frequency resources. The method may include, at 904, transmitting signaling that indicates the scheduling of the one or more radar transmissions or the one or more data transmissions. The method may include, at 906, transmitting the one or more radar transmissions and the one or more data transmissions.

The transmitting device may perform one or more other operations described below or elsewhere herein in connection with the method illustrated in FIG. 9. In some embodiments, a density of time resources of the time-frequency resources that carry the one or more radar transmissions may provide a velocity range for a radar target. For example, the velocity range may include a velocity limit that the radar target should not exceed in order to help ensure that the velocity of the radar target can be measured without ambiguity (e.g., the velocity limit may be a maximum velocity of the radar target that can be accurately measured by the transmitting device). In some embodiments, a time duration of the one or more radar transmissions may provide a velocity resolution for the one or more radar transmissions. In some embodiments, a density of frequency resources of the time-frequency resources may provide a distance range for a radar target. For example, the distance range may include a limit on a distance of the radar target from the transmitting device beyond which the transmitting device cannot measure the distance of the radar target.

In some embodiments, a bandwidth of the one or more radar transmissions may provide a distance resolution for the one or more radar transmissions. In some embodiments, different time resources may be scheduled for different radar transmissions from different cells or beams of a cell, where the different cells or beams of the cell may be different spatial resources. In some embodiments, different frequency resources may be used for radar transmissions from different cells or beams of a cell, where the different cells or beams of the cell may be different spatial resources. In some embodiments, a radar transmission on a spatial beam may be used for a data transmission of the one or more data transmissions. In some embodiments, the one or more data transmissions and the one or more radar transmissions may be jointly used for radar processing. For example, the range, velocity, and/or the like described elsewhere herein may be based on the radar and data signals being sent in the same spatial direction or otherwise being spatially aligned with respect to the spatial resources. In this case, data symbols may be used for radar sensing. In certain embodiments, one or more other time-frequency resources not included in the grid of the time-frequency resources for the one or more radar transmissions may be scheduled for at least one radar transmission of the one or more radar transmissions.

In some embodiments, a subset of the time-frequency resources for the one or more radar transmissions may be excluded for the one or more data transmissions. In some embodiments, the subset may be static from a perspective of the receiving device. In certain embodiments, the one or more radar transmissions and the one or more data transmissions may be scheduled by grouping the one or more radar transmissions across spatial resources. In certain embodiments, the transmitting device may group the one or more radar transmissions across the spatial resources by allocating two or more of the spatial resources on adjacent resources in a time domain or a frequency domain.

As described above, FIG. 9 is provided as an example. Other examples are possible according to some embodiments.

FIG. 10a illustrates an example of an apparatus 10 according to an embodiment. In an embodiment, apparatus 10 may be a transmitting device, node, host, or server in a communications network or serving such a network. For example, apparatus 10 may be a network node, vehicle, aerial vehicle, IoT device, UE, satellite, base station, a Node B, an evolved Node B (eNB), 5G Node B or access point, next generation Node B (NG-NB or gNB), and/or a WLAN access point, associated with a radio access network, such as a LTE network, 5G or NR. In some example embodiments, apparatus 10 may be an eNB in LTE or gNB in 5G.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 10a.

As illustrated in the example of FIG. 10a, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 10a, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, WLAN access point, or the like.

According to certain embodiments, apparatus 10 may be controlled by memory 14 and processor 12 to perform the functions associated with any of the embodiments described herein, such as some operations illustrated in, or described with respect to, FIGS. 1-7 and 9. For instance, apparatus 10 may be controlled by memory 14 and processor 12 to perform the method of FIG. 9.

FIG. 10b illustrates an example of an apparatus 20 according to another embodiment. In an embodiment, apparatus 20 may be receiving device, a node or element in a communications network or associated with such a network, such as a UE, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 10b.

As illustrated in the example of FIG. 10b, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 10b, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry. As discussed above, according to some embodiments, apparatus 20 may be a UE, mobile device, mobile station, ME, IoT device and/or NB-IoT device, for example. According to certain embodiments, apparatus 20 may be controlled by memory 24 and processor 22 to perform the functions associated with any of the embodiments described herein, such as some operations illustrated, or described with respect to, in FIGS. 1-8. For instance, in one embodiment, apparatus 20 may be controlled by memory 24 and processor 22 to perform the method of FIG. 8.

In some embodiments, an apparatus (e.g., apparatus 10 and/or apparatus 20) may include means for performing a method or any of the variants discussed herein, e.g., a method described with reference to FIG. 8 or 9. Examples of the means may include one or more processors, memory, and/or computer program codes for causing the performance of the operation.

Therefore, certain example embodiments provide several technological improvements, enhancements, and/or advantages over existing technological processes. For example, one benefit of some example embodiments is simultaneous transmission of a radar signal and a data transmission based on, for example, multiplexing the radar signal and the data transmissions in time, frequency, and spatial beam domains and/or using a configurable time-frequency comb signal for the radar signal and the data transmission. Accordingly, the use of some example embodiments results in improved functioning of communications networks and their nodes and, therefore constitute an improvement at least to the technological field of transmissions of data and radar signals, among others.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and may include program instructions to perform particular tasks.

A computer program product may include one or more computer-executable components which, when the program is run, are configured to carry out some example embodiments. The one or more computer-executable components may be at least one software code or portions of code. Modifications and configurations used for implementing functionality of an example embodiment may be performed as routine(s), which may be implemented as added or updated software routine(s). In one example, software routine(s) may be downloaded into the apparatus.

As an example, software or a computer program code or portions of code may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, such as a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein apply equally to both singular and plural implementations, regardless of whether singular or plural language is used in connection with describing certain embodiments. For example, an embodiment that describes operations of a single network node equally applies to embodiments that include multiple instances of the network node, and vice versa.

One having ordinary skill in the art will readily understand that the example embodiments as discussed above may be practiced with operations in a different order, and/or with hardware elements in configurations which are different than those which are disclosed. Therefore, although some embodiments have been described based upon these example preferred embodiments, it would be apparent to those of skill in the art that certain modifications, variations, and alternative constructions would be apparent, while remaining within the spirit and scope of example embodiments.

### Partial Glossary

CRS Cell-specific Reference Signal

DCI Downlink Control Information

DL Downlink

HW Hardware

NR New Radio

OFDM Orthogonal Frequency Division Multiplex

PBCH Physical Broadcast Channel

PRB Physical Resource Block

PSS Primary Synchronization Signal

QAM Quadrature Amplitude Modulation

RADAR Radio Detection and Ranging

RE Resource Element

RRC Radio Resource Control

SCS Sub Carrier Spacing

SNR Signal to Noise Ratio

SSB Synchronization Signal Block

SSS Secondary Synchronization Signal

TDM Time Division Multiplex

UE User Equipment

1. A method, comprising:
scheduling, by a transmitting device, one or more radar transmissions and one or more data transmissions by:
utilizing a grid of time-frequency resources for the one or more radar transmissions, and
multiplexing the one or more radar transmissions and the one or more data transmissions with each other with respect to the grid of time-frequency resources; said method further comprising:
transmitting signaling that indicates the scheduling of the one or more radar transmissions or the one or more data transmissions; and
transmitting the one or more radar transmissions and the one or more data transmissions.

2. The method according to claim 1, wherein a density of time resources of the time-frequency resources that carry the one or more radar transmissions provides a velocity range for a radar target.

3. The method according to claim 1, wherein a time duration of the one or more radar transmissions provides a velocity resolution for the one or more radar transmissions.

4. The method according to claim 1, wherein a density of frequency resources of the time-frequency resources provides a distance range for a radar target.

5. The method according to claim 1, wherein a bandwidth of the one or more radar transmissions provides a distance resolution for the one or more radar transmissions.

6. The method according to claim 1, wherein different time resources are scheduled for different radar transmissions from different cells or beams of a cell, wherein the different cells or beams of the cell are different spatial resources.

7. The method according to claim 1, where different frequency resources are used for radar transmissions from different cells or beams of a cell, wherein the different cells or beams of the cell are different spatial resources.

8. The method according to claim 1, wherein a radar transmission on a spatial beam is used for a data transmission of the one or more data transmissions.

9. The method according to claim 1, wherein the one or more data transmissions and the one or more radar transmissions are jointly used for radar processing.

10. The method according to claim 1, wherein one or more other time-frequency resources not included in the grid of the time-frequency resources for the one or more radar transmissions are scheduled for at least one radar transmission of the one or more radar transmissions.

11. The method according to claim 1, wherein a subset of the time-frequency resources for the one or more radar transmissions are excluded for the one or more data transmissions.

12. (canceled)

13. The method according to claim 1, wherein scheduling the one or more radar transmissions and the one or more data transmissions further comprises:
scheduling the one or more radar transmissions and the one or more data transmissions by grouping the one or more radar transmissions across spatial resources.

14. (canceled)

15. A apparatus, comprising:
at least one processor; and
at least one memory comprising computer program code,
the at least one memory and computer program code configured, with the at least one processor, to cause the apparatus at least to perform
receiving, by a receiving device, signaling that indicates a scheduling of one or more radar transmissions or one or more data transmissions according to:
a grid of time-frequency resources for the one or more radar transmissions, and
a multiplexing of the one or more radar transmissions and the one or more data transmissions with each other with respect to the grid of time-frequency resources; and
receiving, based on the scheduling, the one or more data transmissions on one or more time or frequency resources that are not scheduled for the one or more radar transmissions.

16-19. (canceled)

20. The apparatus according to claim 15, configured to perform:
receiving the one or more radar transmissions.

21-22. (canceled)

23. An apparatus, comprising:
at least one processor; and
at least one memory comprising computer program code,
the at least one memory and computer program code configured, with the at least one processor, to cause the apparatus at least to perform
scheduling, by a transmitting device, one or more radar transmissions and one or more data transmissions by:
utilizing a grid of time-frequency resources for the one or more radar transmissions, and
multiplexing the one or more radar transmissions and the one or more data transmissions with each other with respect to the grid of time-frequency resources; said method further comprising:
transmitting signaling that indicates the scheduling of the one or more radar transmissions or the one or more data transmissions; and
transmitting the one or more radar transmissions and the one or more data transmissions.

24-26. (canceled)
